(19) United States
(12) Patent Application Publication
(10) Pub. No.: US 2011/0210260 A1
(43) Pub. Date: Sep. 1, 2011

(54) ELECTROMAGENTIC-WAVE GENERATION DEVICE

(75) Inventor: Ryota Sekiguchi, Kawasaki-shi (JP)

(73) Assignee: CANON KABUSHIKI KAISHA, Tokyo (JP)

(21) Appl. No.: 13/033,480

(22) Filed: Feb. 23, 2011

(30) Foreign Application Priority Data
Feb. 26, 2010 (JP) 2010-041134

(51) Int. Cl. G01J 1/42; G21G 4/00

(52) U.S. Cl. 250/393; 250/493.1

(57) ABSTRACT

An electromagnetic-wave generation device including an emitter section including a first electrode, a collector section including a second electrode, a carrier-travel section placed between the emitter section and the collector section, a voltage-application unit configured to apply a voltage so that a potential of the second electrode becomes higher than a potential of the first electrode, and a light-irradiation unit configured to radiate light is provided, where the carrier-travel section includes a first semiconductor extending along a direction in which an electron carrier travels, and where the emitter section includes a second semiconductor that is formed in contact with the first semiconductor, and that achieves a potential barrier, and is configured so that the carrier goes beyond the potential barrier and is emitted to the carrier-travel section only when being irradiated with the light.

### BACKGROUND OF THE INVENTION

1. Field of the Invention

The present invention relates to an electromagnetic-wave generation device configured to generate an electromagnetic wave by performing excitation-light irradiation.

2. Description of the Related Art

An electromagnetic wave including a component obtained in a frequency range from the millimeter-wave band to the terahertz-wave band (from 30 GHz to 30 THz inclusive), which is simply referred to as a terahertz wave in this specification, has the following characteristics. First, the electromagnetic wave passes through a nonmetal material as an X-ray does. Secondly, the frequency range includes many absorption spectrums indigenous to biomolecules, pharmaceuticals, etc. Thirdly, the electromagnetic wave has a spatial resolution appropriate in many imaging uses.

Due to the above-described characteristics of the terahertz wave, the technology of performing the spectral analysis inside a material, a safe transillumination-imaging apparatus replacing an X-ray, the technology of analyzing biomolecules, pharmaceuticals, etc. have been developed as the application fields of the terahertz wave. A terahertz-wave generation method performed by using a photoconductive element is widely used as the method of generating the terahertz wave. The photoconductive element includes a special semiconductor having relatively large mobility and the carrier life not more than a picosecond long, and two electrodes provided on the semiconductor. When light is applied to the gap between the electrodes in the state where a voltage is applied between the electrodes, a picosecond-order current flows between the electrodes and the terahertz wave is emitted.

The intensity of an electric field provided between the electrodes should be increased to increase an output of the terahertz wave. A generation apparatus provided to increase the electric field intensity has been disclosed in Japanese Patent Laid-Open No. 2006-074021. The generation apparatus does not include the above-described photoconductive element. The generation apparatus illustrated in FIG. 10 includes a substrate 11, a vacuum part 15, a positive electrode 12, and a negative electrode 13. The surface part of the negative electrode 13 includes a photoelectric plane 14 provided to emit an electron 16 to the vacuum part 15 by being irradiated with light. The material of the photoelectric plane 14 includes Sb, K, Na, Cs, etc. A power source 20 applies a relatively high voltage to the gap between the positive electrode 12 and the negative electrode 13, where the vacuum part 15 lies therebetween.

Unlike the photoconductive element, a time period τ during which a current emitted from the photoelectric plane 14 flows is determined based on a distance d of the gap between the positive electrode 12 and the negative electrode 13, and the voltage V. For example, when the voltage V applied to the gap between the electrodes 12 and 13 is 100V, and the gap distance d is 2 μm, the time period τ is estimated to be 0.67 psec. Accordingly, when the photoelectric plane 14 is irradiated with pulse light 131 having a short width measured in femtoseconds (with a wavelength of about 780 nm), the pulse light 131 being emitted from a laser device 30, an induced current flows into an antenna (between the electrodes 12 and 13) only during the time period τ, and a terahertz wave is emitted from the antenna. Thus, the technology disclosed in Japanese Patent Laid-Open No. 2006-074021 achieves a larger electric-field intensity and a larger output of the terahertz wave than the method performed by using the photoconductive element.

The emission current properties of the above-described electromagnetic-wave generation apparatus will be described below. Firstly, since the emission current properties of a vacuum-tube element correspond to the function of an electric field provided between the negative and positive electrodes, the distance between the negative and positive electrodes should be highly consistent throughout the width of each of the electrodes, which is difficult due to processing accuracy. Secondly, since the emission current properties of the vacuum-tube element depend on the work function of the material of the negative electrode, a change in the work function, which is caused by, for example, the adhesion of an adsorption material to the surface of the vacuum-tube element, may cause an emission current to change. Thus, the emission current properties of the electromagnetic-wave generation apparatus, which has the original characteristics of the above-described vacuum-tube element, should be more stable.

### SUMMARY OF THE INVENTION

The present invention provides an electromagnetic-wave generation device including an emitter section including a first electrode, a collector section including a second electrode, a carrier-travel section placed between the emitter section and the collector section, a voltage-application unit configured to apply a voltage so that a potential of the second electrode becomes higher than a potential of the first electrode, and a light-irradiation unit configured to radiate light, wherein the carrier-travel section includes a first semiconductor extending along a direction in which an electron carrier travels, and wherein the emitter section includes a second semiconductor that is formed in contact with the first semiconductor, and that achieves a potential barrier, and is configured so that the carrier goes beyond the potential barrier and is emitted to the carrier-travel section only when being irradiated with the light.

According to an embodiment of the present invention, the vacuum provided in the related art is replaced by a solid semiconductor (usually, a substantially intrinsic semiconductor thinner than the mean free path), which allows for the ballistic flight of an electron (or a hole), the ballistic flight being substantially the same as that achieved in a vacuum. The use of the solid semiconductor allows for selecting the method of manufacturing a solid element that can control the distance between an emitter and a collector with high precision, where the semiconductor is placed between the emitter and the collector. Consequently, an electromagnetic-wave generation device with stable emission current properties can be achieved.

Further features of the present invention will become apparent from the following description of exemplary embodiments with reference to the attached drawings.

### BRIEF DESCRIPTION OF THE DRAWINGS

FIG. 1A is a sectional view illustrating an exemplary configuration of an electromagnetic-wave generation device according to a first embodiment of the present invention.

FIG. 1B illustrates an exemplary band profile of the electromagnetic-wave generation device according to the first embodiment.

FIG. 2A is a sectional view illustrating an exemplary configuration of an electromagnetic-wave generation device according to a second embodiment of the present invention.

FIG. 2B illustrates an exemplary band profile of the electromagnetic-wave generation device according to the second embodiment.

FIG. 3A is a sectional view illustrating an exemplary configuration of an electromagnetic-wave generation device according to a third embodiment of the present invention.

FIG. 3B illustrates an exemplary band profile of the electromagnetic-wave generation device according to the third embodiment.

FIG. 4A is a sectional view illustrating an exemplary configuration of an electromagnetic-wave generation device according to a fourth embodiment of the present invention.

FIG. 4B illustrates an exemplary band profile of the electromagnetic-wave generation device according to the fourth embodiment.

FIG. 5A is a sectional view illustrating an exemplary configuration of an electromagnetic-wave generation device according to a fifth embodiment of the present invention.

FIG. 5B is a top view illustrating the exemplary configuration of the electromagnetic-wave generation device according to the fifth embodiment.

FIG. 6A is a sectional view illustrating an exemplary configuration of an electromagnetic-wave generation device according to a sixth embodiment of the present invention.

FIG. 6B illustrates an exemplary band profile of the electromagnetic-wave generation device according to the sixth embodiment.

FIG. 6C is a top view illustrating the exemplary configuration of the electromagnetic-wave generation device according to the sixth embodiment.

FIG. 7A is a sectional view illustrating an exemplary configuration of an electromagnetic-wave generation device according to a seventh embodiment of the present invention.

FIG. 7B illustrates an exemplary band profile of the electromagnetic-wave generation device according to the seventh embodiment.

FIG. 7C is a top view illustrating the exemplary configuration of the electromagnetic-wave generation device according to the seventh embodiment.

FIG. 8A is a sectional view illustrating an exemplary configuration of an electromagnetic-wave generation device according to an eighth embodiment of the present invention.

FIG. 8B illustrates an exemplary band profile of the electromagnetic-wave generation device according to the eighth embodiment.

FIG. 9 schematically illustrates an exemplary configuration of a terahertz-time-domain spectroscopic system including an electromagnetic-wave generation device.

FIG. 10 schematically illustrates a known electromagnetic-wave generation apparatus.

### DESCRIPTION OF THE EMBODIMENTS

In an electromagnetic-wave generation device according to an embodiment of the present invention, carriers of an emitter section including a first electrode are excited by being irradiated with light, and go beyond a potential barrier including a second semiconductor formed in contact with a first semiconductor constituting a carrier-travel section. Consequently, the carriers are accelerated with the carrier-travel section. Since the second semiconductor, which constitutes the potential barrier of the emitter section, is in contact with the first semiconductor, it becomes possible to stabilize the travel distance of each of the carriers and avoid the adhesion of an adsorption material to the surface of the carrier-travel section. Along these lines of thought, the electromagnetic-wave generation device is basically configured as described above.

Although the irradiation light is time-modulated light in ordinary cases, the irradiation light may be continuous light. In the case where the continuous light is used, light having two types of frequencies, where the difference between the frequencies falls within the terahertz area, is used as the irradiation light. Further, for setting the ballistic-flight distance of an electron (or a hole) with increased precision, the carrier-travel section may include the first semiconductor having a length not more than a mean free path defined along the direction in which the carriers travel. Further, the carrier-travel section may be provided as the first semiconductor including an intrinsic or substantially intrinsic semiconductor.

Hereinafter, embodiments of the present invention will be described with reference to the attached drawings.

### First Embodiment

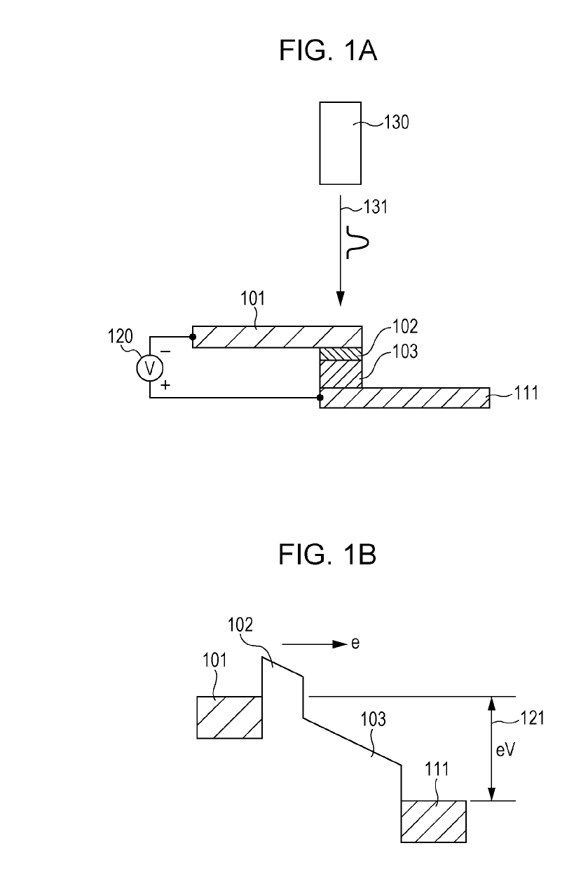

An electromagnetic-wave generation device according to a first embodiment of the present invention will be described with reference to FIGS. 1A and 1B. FIG. 1A is a sectional view of the electromagnetic-wave generation device of the present embodiment. FIG. 1B illustrates a band profile obtained along a section of the electromagnetic-wave generation device of the present embodiment. Each of FIGS. 1A and 1B illustrates a first electrode 101 provided to supply an electron to the emitter section and a semiconductor-potential barrier 102 including a semiconductor (second semiconductor) which is thick enough not to allow an electron (or a hole) to tunnel through the semiconductor. In the present embodiment, both the electrode 101 and the semiconductor-potential barrier 102 constitute the emitter section. Therefore, the semiconductor-potential barrier 102 is designed so that the height thereof is slightly lower than the photon energy of excitation light 131 which will be described later with respect to the Fermi energy of the electrode 101.

A carrier-travel section 103 includes an intrinsic or substantially intrinsic semiconductor (a first semiconductor) thinner than the mean free path. Usually, the thickness of the semiconductor is of the order of 10 nm to 100 nm at ambient temperatures. The expression “substantially intrinsic” indicates that the semiconductor may not be thoroughly intrinsic. That is, the electron (or hole) density of the semiconductor should be low enough that an electric field can be applied to the semiconductor. Usually, the value of the electron (or hole) density may be 10¹⁶ cm⁻³ or less. The carrier-travel section 103 is in contact with the semiconductor-potential barrier 102, and the interface between the carrier-travel section 103 and the semiconductor-potential barrier 102 is not exposed to the ambient atmosphere. Consequently, the adhesion of an adsorption material or the like to the surface of the carrier-travel section is reduced. A second electrode 111 is provided to extract an electron from a collector section. In the present embodiment, only the electrode 111 constitutes the collector section.

A voltage source 120 is a voltage-application section provided to apply a voltage 121 between the electrodes 101 and 111. The voltage source 120 applies the voltage 121 so that the potential of the second electrode 111 is increased with respect to the first electrode 101. A light-laser device 130 is a light-irradiation section. In the first embodiment, the light-laser device 130 emits pulse light 131 having a short width measured in femtoseconds, with which the first electrode 101 provided directly above the semiconductor-potential barrier 102 is irradiated. At that time, the photon energy of the pulse light 131 is higher than the height of the semiconductor-potential barrier 102. Therefore, a photoexcited electron is emitted toward the second electrode 111 having a high potential. When an electron is excited with energy lower than the photon energy, the electron is not emitted because it is unlikely that the energy of the electron will exceed the height of the semiconductor-potential barrier 102. The above-described low energy may include thermal energy (of a few tens of millielectron volts, for example) so that the electron is thermally excited with the thermal energy.

A time period τ during which an emitted current flows is determined depending mainly on the material and thickness d of the carrier-travel section 103 including the first semiconductor. The dependence on the material indicates that the time period τ is determined in relation to a saturated-electron speed vₛ measured inside the material. Usually, the saturated-electron speed vₛ is of the order of 10⁷ cm/sec. If the assumption is made that the saturated-electron speed vₛ is 10⁷ cm/sec and an electron-travel speed v_{d} also reaches 10⁷ cm/sec, the time period τ is estimated to be 0.5 psec, where the thickness d of the carrier-travel section 103 is 50 nm. The above-described estimation is made based on the expression τ=d/v_{d}, which is an approximate expression. Since the above-described thickness or the like is adjusted considering the time of the electron excitation performed with the short-pulse light 131 and the time of the electron relaxation performed in the collector section, the precision of the above-described estimation can be increased.

Regarding the electric-field dependence, the time period τ and the electric field intensity are related to each other so that the time period τ decreases with increases in the electric field intensity. However, the relationship is restricted by the semiconductor material. Considering the fact that the electron speed usually becomes saturated with an electric field intensity on the order of 10 kV/cm, the time period τ is not decreased due to an electric field intensity not less than the electric field intensity on the order of 10 kV/cm. Therefore, a large voltage may not be provided for the above-described nano configuration. The adequate value of the voltage 121 applied between the electrodes 101 and 111 is about 1V. When the pulse light 131 having the short width measured in femtoseconds is applied at that time, an induced current flows between the electrodes 101 and 111 only during the time period τ. When the electrodes 101 and 111 are arranged in the form of an antenna, a terahertz wave is emitted from the antenna. An emission pattern is determined based on the antenna. When the bandwidth of the emitted terahertz wave is simply estimated where 1/τ is given, the value of the bandwidth becomes 2 THz.

The present embodiment allows for controlling the distance between an emitter and a collector with high precision, where a semiconductor is placed between the emitter and the collector, setting the travel distance of a carrier with appropriate precision, and stabilizing the emission current properties. The emission current properties of the vacuum-tube element achieved by the known technology depend on tunneling of electrons, which occurs in a potential barrier generated by bending a vacuum level. Therefore, when the electron energy is slightly changed due to thermal energy or the like, the thickness of the potential barrier corresponding to the changed electron energy is varied and an emission current may be easily varied. On the other hand, in the present embodiment, the potential barrier achieved by the vacuum level is replaced with the bottom of a conduction band (or the top of a valence band) obtained in a different semiconductor connected to the emitter.

Therefore, the present embodiment can provide a potential barrier with a short height relative to the work function of metal, such as few electron volts (about 2 eV for Cs, which is relatively low as the work function of metal). Further, the above-described potential barrier does not depend on the tunneling of carriers. That is, the present embodiment allows for changing a known electromagnetic-wave generation device achieved by using a vacuum into a solid element and stabilizing the emission current properties. Further, the semiconductor 102 constituting the potential barrier and the semiconductor 103 can be provided as the same semiconductor in the above-described configuration. In that case, the potential barrier is achieved by forming a Schottky barrier junction between the semiconductor and the electrode, which makes it difficult to control the potential barrier. However, the above-described configuration can be used when the interface treatment and/or the material selection is appropriately performed. Further, holes may be used as the carriers in the above-described configuration. In that case, the polarity of the voltage 120 is reversed, and the band profile is vertically flipped in the above-described configuration.

### Second Embodiment

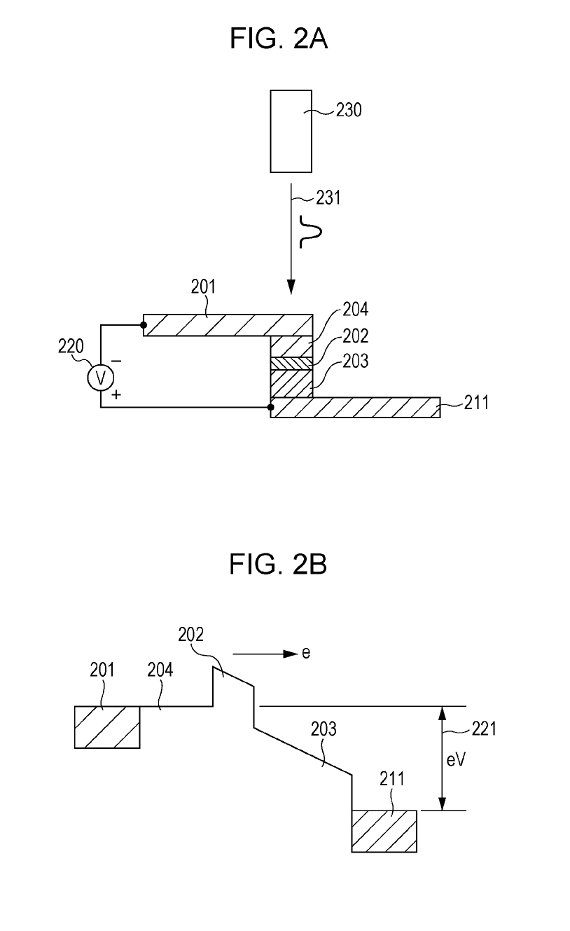

An electromagnetic-wave generation device according to a second embodiment of the present invention will be described with reference to FIGS. 2A and 2B. FIG. 2A is a sectional view of the electromagnetic-wave generation device of the present embodiment. FIG. 2B illustrates a band profile obtained along a section of the electromagnetic-wave generation device of the present embodiment. In the present embodiment, a first electrode 201, a potential barrier 202, a carrier-travel section 203, a second electrode 211, a voltage-application section 220, and a light-irradiation section 230 are the same as the corresponding components of the first embodiment. However, the configuration of an emitter section of the present embodiment is different from that of the first embodiment. A semiconductor 204 is placed between the first electrode 201 and the potential barrier 202 including a second semiconductor, and is in contact with the potential barrier 202. As the conductivity of the semiconductor 204, either the n-type conductivity or the p-type conductivity is selected so that the conductivity type of the semiconductor 204 becomes equivalent to that of each of carriers of the carrier-travel section 203.

In the present embodiment, the electrode 201, the conductive semiconductor 204, and the semiconductor-potential barrier 202 constitute the emitter section. Therefore, the height of the potential barrier 202 is designed with reference to the Fermi energy of the conductive semiconductor 204. For example, the carrier density of the conductive semiconductor 204 is adjusted so that the value of the carrier density is of the order of 10¹⁸ cm⁻³ to 10¹⁹ cm⁻³. In that case, the Fermi energy lies near the bottom of the carrier-conduction band. Consequently, the height of the potential barrier can be designed based on the band offset between the semiconductor 204 and the potential barrier 202 including the second semiconductor with respect to the Fermi energy of the first electrode 201, that is, the Fermi energy of the semiconductor 204. For example, the band offset between semiconductors is usually designed to be 0.5 eV. In that case, therefore, the value of the wavelength (photon energy) of the corresponding excitation light 231 may be 2.4 μm or less (0.5 eV or more).

An operation method according to the present embodiment will be described. The voltage-application section 220 applies a voltage 221 to the gap between the electrodes 201 and 211 as is the case with the first embodiment. In the present embodiment, the light-irradiation section 230 emits short-pulse light 231 with which the conductive semiconductor 204 provided directly above the semiconductor-potential barrier 202 is irradiated. However, according to the arrangement illustrated in FIG. 2A, the electrode 201 interferes with the transmission of the short-pulse light 231. Therefore, the short-pulse light 231 may be emitted from the light-irradiation section 230 arranged in an obliquely-upward direction or a lateral direction. As a matter of course, the transmittance of the short-pulse light 231 can be increased when the thickness of the electrode 201 is decreased or when a transparent electroconductive film including indium-tin oxide (ITO), zinc oxide (ZnO), etc. is used as the material of the electrode 201.

Thus, the excitation light used in the present embodiment may have a relatively long wavelength. Therefore, it becomes possible to select an appropriate band offset and use a 1.5 μm-band fiber laser device achieved at a relatively low cost, as the light-irradiation section. Other specifics of the present embodiment are the same as those of the first embodiment.

### Third Embodiment

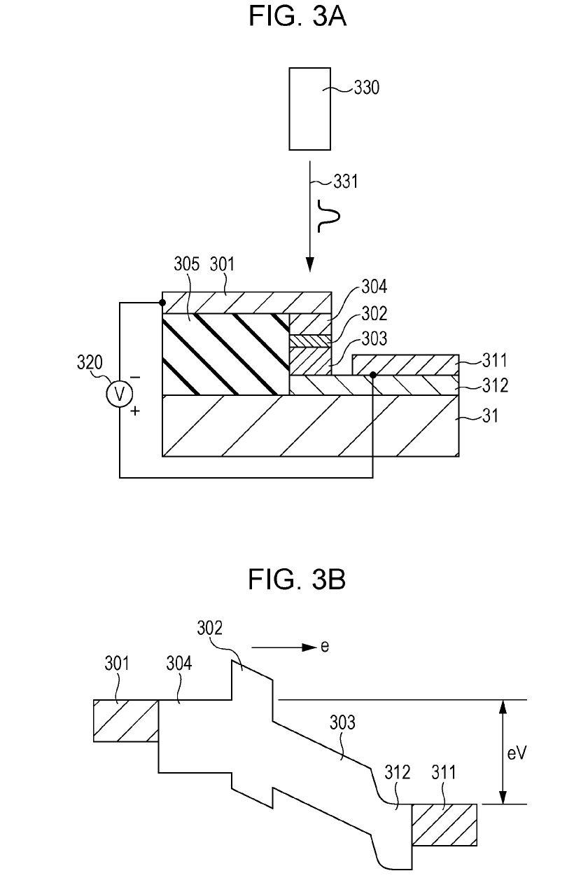

An electromagnetic-wave generation device according to a third embodiment of the present invention will be described with reference to FIGS. 3A and 3B. FIG. 3A is a sectional view of the electromagnetic-wave generation device of the present embodiment. FIG. 3B illustrates a band profile obtained along a section of the electromagnetic-wave generation device of the present embodiment. FIG. 3B illustrates the case where an electron is exemplarily selected as the carrier. In the present embodiment, a first electrode 301, a conductive semiconductor 304, a potential barrier 302, a carrier-travel section 303, a second electrode 311, a voltage-application section 320, and a light-irradiation section 330 are the same as the corresponding components of the second embodiment. However, the configuration of a collector section of the present embodiment is different from that of the second embodiment.

A conductive semiconductor 312 is referred to as a sub-collector, and is provided to flexibly determine the position of the second electrode 311 and provide the configuration of the second embodiment on a substrate 31. Accordingly, the second electrode 311 and the sub-collector 312 constitute the collector section in the present embodiment. Therefore, when a semiconductor substrate is selected as the substrate 31, the present embodiment can be achieved with a well-known semiconductor-process technology such as providing semiconductor layers 312, 303, 302, and 304 in that order through crystal growth, and providing an insulator 305 on the substrate 31. That is, the present embodiment can be achieved by stacking the collector section, the carrier-travel section, and the emitter section on one another in that order. The stacking procedures are performed based on the method of manufacturing a well-known heterojunction bipolar transistor (HBT). As the conductivity of the sub-collector 312, either the n-type conductivity or the p-type conductivity is selected so that the conductivity type of the sub-collector 312 becomes the same as that of each of carriers of the carrier-travel section 303. Further, an adjustment is made to maximize the carrier density.

The operation method of the present embodiment is equivalent to that of the second embodiment. However, consideration should be given to the time consumed for carrier relaxation performed in the semiconductor 312. The choice of which material of the semiconductor 312 referred to as the sub-collector to use may be determined so that the value of energy gap becomes greater than that of the photon energy of excitation light 331. Consequently, the electrical conductivity of the semiconductor 312 is not significantly changed due to optical carriers that are generated by excitation light 331.

### Fourth Embodiment

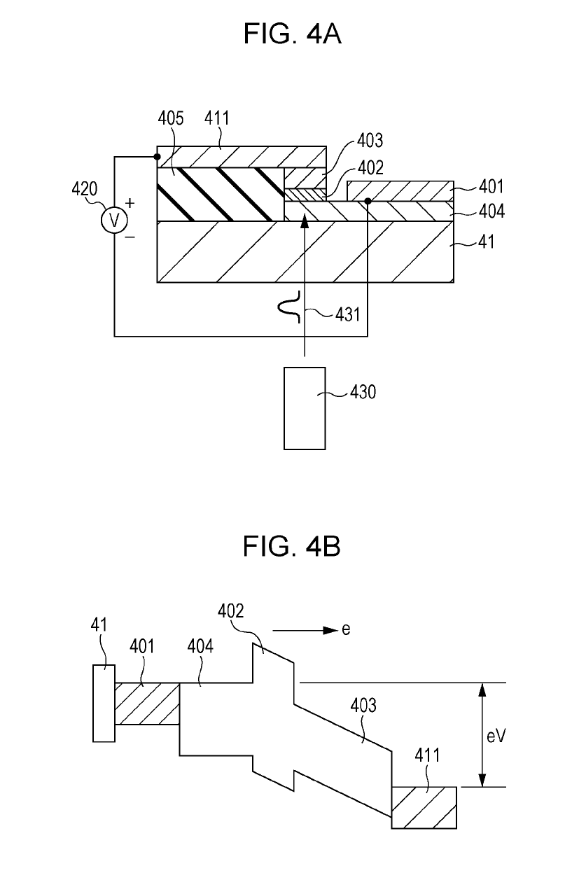

An electromagnetic-wave generation device according to a fourth embodiment of the present invention will be described with reference to FIGS. 4A and 4B. FIG. 4A is a sectional view of the electromagnetic-wave generation device of the present embodiment. FIG. 4B illustrates a band profile obtained along a section of the electromagnetic-wave generation device of the present embodiment. FIG. 4B illustrates the case where an electron is selected as the carrier. In the present embodiment, a first electrode 401, a conductive semiconductor 404, a potential barrier 402, a carrier-travel section 403, a second electrode 411, a voltage-application section 420, and a light-irradiation section 430 are the same as the corresponding components of the third embodiment. However, the present embodiment is different from the third embodiment in that the conductive semiconductor 312 is eliminated and the position of a substrate 41 is flipped in the vertical direction on the drawing.

Therefore, consideration may not be given to the time consumed for carrier relaxation performed in the above-described semiconductor 312. That is, according to the carrier-relaxation mechanism of a semiconductor, the carrier relaxation is usually achieved within a time period of several picoseconds mainly by longitudinal optical phonon scattering at ambient temperatures. Therefore, when the electromagnetic-wave generation device of the present embodiment is designed so that the time period τ during which an emitted current flows is of the order of several picoseconds or less, consideration should be given to the relaxation time. In that sense, the present embodiment has a simple carrier-conduction mechanism which is the same as that of each of the first and second embodiments, where the carrier relaxation directly occurs within an electrode.

The present embodiment can be achieved with the semiconductor-process technology such as providing semiconductor layers 404, 402, and 403 in that order through crystal growth, and providing an insulator 405 on the substrate 41. That is, the present embodiment can be achieved by stacking the emitter section, the carrier-travel section, and the collector section on one another in that order.

The operation method of the present embodiment is the same as that of the third embodiment. That is, in the present embodiment, a conductive semiconductor 404 provided directly below the semiconductor-potential barrier 402 is irradiated with short-pulse light 431 emitted from the light-irradiation section 430. However, since the position of the substrate 41 is flipped, the short-pulse light 431 having a short width measured in femtoseconds passes through the substrate 41. Therefore, the substrate 41 includes a material which is transparent and low scattering for excitation light 431. When a semiconductor substrate is selected as the substrate 41, for example, the value of the band gap of the semiconductor substrate 41 should at least be higher than that of the photon energy of the excitation light 431. Otherwise, a hole may be bored into part of the substrate 41 so that light is introduced from the backside to the conductive semiconductor 404 provided directly below the semiconductor-potential barrier 402.

### Fifth Embodiment

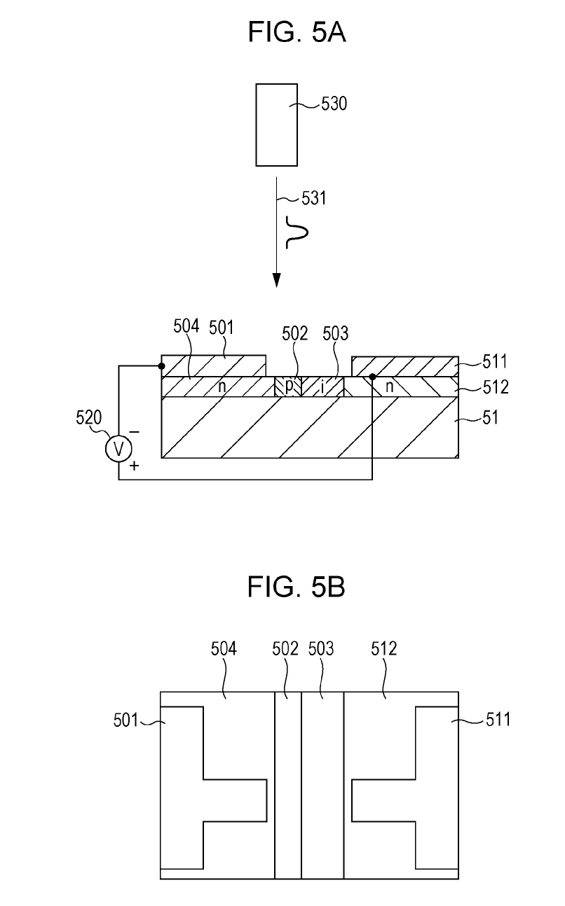

An electromagnetic-wave generation device according to a fifth embodiment of the present invention will be described with reference to FIGS. 5A and 5B. FIG. 5A is a sectional view of the electromagnetic-wave generation device of the present embodiment. FIG. 5B is a top view of the electromagnetic-wave generation device of the present embodiment. In the present embodiment, a first electrode 501, a second electrode 511, a voltage-application section 520, and a light-irradiation section 530 are the same as the corresponding components of the third embodiment. A conductive semiconductor 504, a potential barrier 502, a carrier-travel section 503, and a conductive semiconductor 512 are horizontally arranged. In the present embodiment, the first electrode 501, the conductive semiconductor 504, and the potential barrier 502 constitute an emitter section, and the second electrode 511 and the conductive semiconductor 512 constitute a collector section. Thus, the present embodiment indicates that the present invention can also be achieved by providing a lateral-type electromagnetic-wave generation device even though each of the above-described embodiments provides a vertical-type electromagnetic-wave generation device.

When an intrinsic or substantially intrinsic semiconductor substrate is selected as a substrate 51, for example, the present embodiment can be achieved through the well-known semiconductor-process technology such as implanting ions in the potential barrier 502 and the conductive semiconductors 504 and 512 in sequence, where the potential barrier 502 functions as a p-type semiconductor area, and each of the conductive semiconductors 504 and 512 functions as an n-type semiconductor area. The present embodiment can also be achieved through heterojunction performed through the use of a sloped substrate created with increased precision. In the present embodiment, the conductivity of the potential barrier 502 is the p-type conductivity opposite to that of an electron flying within the carrier-travel section 503. The height of the potential barrier 502 can be controlled based on the carrier density.

The operation method of the present embodiment is the same as that of the third embodiment. That is, in the present embodiment, the conductive semiconductor 504 adjacent to the semiconductor-potential barrier 502 is irradiated with excitation light 531 emitted from the light-irradiation section 530. The conductive semiconductor 504 is directly irradiated with the excitation light 531, that is, femtosecond-pulse light (the light 531 may preferably be applied to a part near the interface between the semiconductors 504 and 502). Therefore, the light efficiency of the present embodiment is better than those of the above-described vertical-type electromagnetic-wave generation devices.

In the present embodiment, a horizontal electric field extending along an electric line of force occurring between the electrodes 501 and 511 is applied to the carrier-travel section 503. Therefore, the time period τ during which an emitted current flows is determined depending mainly on the material and the lateral length d of the carrier-travel section 503. That is, in the present embodiment, the time period τ is determined in relation to the semiconductor length defined along the carrier-travel direction. Other details of the derivation of the time period τ are the same as those of the first embodiment. Accordingly, when the femtosecond-pulse light 531 is emitted, an induced current flows between the electrodes 501 and 511 only during the time period τ. In the present embodiment, the electrodes 101 and 111 are arranged in the form of a dipole antenna. As the antenna form, the form of each of the dipole antenna, a bow-tie antenna, and so forth is widely known. An emission pattern is tilted toward higher permittivity, that is, the substrate-51 side, because the antenna clings to the substrate 51.

The electromagnetic-wave generation devices described above will be described in detail in the following embodiments.

### Sixth Embodiment

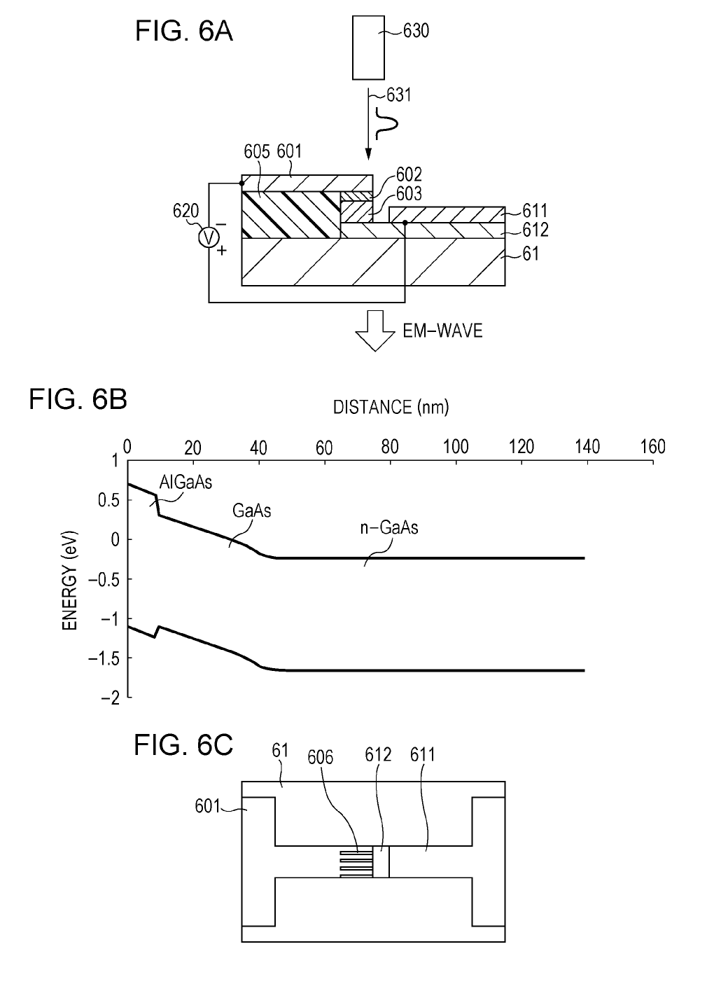

An electromagnetic-wave generation device according to a sixth embodiment will be described with reference to FIGS. 6A, 6B, and 6C. FIG. 6A is a sectional view of the electromagnetic-wave generation device of the present embodiment. FIG. 6B illustrates the band profile of a semiconductor part, which is obtained along a section of the electromagnetic-wave generation device of the present embodiment. FIG. 6C is a top view of the electromagnetic-wave generation device of the present embodiment. The present embodiment includes a combination of the first and third embodiments.

Each of FIGS. 6A and 6C illustrates a GaAs substrate on which the present embodiment is provided, Ti/Pt/Au electrode (first electrode) 601, and a potential barrier 602 including a 10-nanometer-thick AlGaAs (the composition ratio of Al is 30%) layer. In the present embodiment, the electrode 601 and the AlGaAs potential barrier 602 constitute an emitter section. Therefore, the height of the potential barrier 602 matches up with that of a Schottky barrier including Ti and AlGaAs, and the value of the height is about 0.7 eV. A travel section 603 includes a 30-nanometer-thick undoped GaAs layer. Since the electron density of the travel section 603 should only be sufficiently smaller than that of the environment, the travel section 603 may include the undoped GaAs. Further, a semiconductor layer 612 includes a 100-nanometer-thick n-GaAs layer with an electron density of 1×10¹⁹ cm⁻³ and a band gap of 1.4 eV. An electrode 611 is a Ti/Pt/Au electrode (a second electrode). In the present embodiment, the Ti/Pt/Au electrode 611 and the semiconductor layer 612 functioning as a sub-collector constitute a collector section.

FIG. 6B illustrates the band profile of a semiconductor part of the present invention, which is calculated with a Poisson solver. When the band profile is calculated on the precondition that the travel section 603 has a donor density of 1×10¹⁶ cm⁻³, no substantial change occurs in the band profile. The above-described configuration is provided on the GaAs substrate 61 with a well-known semiconductor-process technology such as providing semiconductor layers 612, 603, and 602 in sequence through crystal-growth by using the molecular beam epitaxy (MBE) method or the metal-organic vapor phase epitaxy (MOVPE) method, etching the semiconductors 612, 603, and 602 so that the semiconductors are processed into a mesa, performing passivation by using an SiO₂ layer 605, etc. The mesa should have a small area to minimize the RC time constant, and the small area should be a little larger than a projected area obtained by the light irradiation. In the present embodiment, the value of the small area is determined to be 10 μm×10 μm.

For performing operations of the present embodiment, a voltage is applied from a voltage source 620 between the electrodes 601 and 611 so that the electric field intensity of the travel section 603 is adjusted to about 50 V/cm. In the present embodiment, a 1.5 μm-band fiber laser device configured to oscillate short-pulse light having a width of a few tens of femtoseconds is used. The Ti/Pt/Au electrode 611 provided directly above the AlGaAs-potential barrier 602 is irradiated with Femtosecond-pulse light 631. Since a wavelength of 1.5 μm corresponds to the photon energy 0.8 eV, an electron can be photoexcited so that the electron can go beyond the AlGaAs-potential barrier 602 having a height of about 0.7 eV. Further, the sub-collector 612 is designed to have a band gap of about 1.4 eV so that the electrical conductivity of the sub-collector 612 is not significantly changed due to the irradiation of the Femtosecond-pulse light 631, that is, the excitation light 631.

In FIG. 6C, the first electrode 601 includes an interdigital-shaped part illustrated with reference numeral 606. Since the first electrode 601 includes the interdigital-electrode part 606 so as not to interfere with the transmission of the light 631, the light efficiency of the present embodiment is increased to a certain degree. The time period τ during which an emitted current flows depends on the material of the GaAs-travel section 603. When an electric field of 20 to 200 kV/cm is applied to GaAs at ambient temperatures, the value of electron-travel speed v_{d} is about 0.8×10⁷ cm/sec, which is found on referring to “J. S. Blakemore, Jour. Appl. Phys. Vol. 53, 8123 (1982)” describing an investigation of the material characteristics of GaAs. Accordingly, it can be estimated that the equation τ=0.38 psec holds based on the equation τ=d/Vd. Since a radiation pattern is radiated toward the GaAs substrate 61 having high permittivity, a semi-insulating substrate 61 decreasing the loss of the THz wave may be used.

### Seventh Embodiment

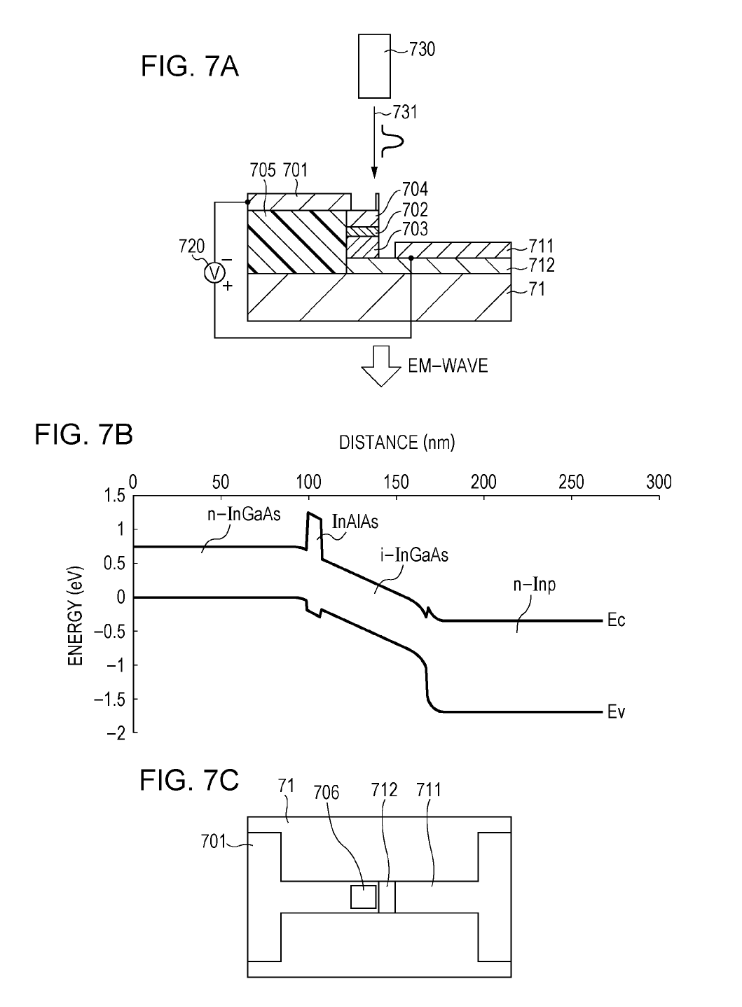

An electromagnetic-wave generation device according to a seventh embodiment will be described with reference to FIGS. 7A, 7B, and 7C. FIG. 7A is a sectional view of the electromagnetic-wave generation device of the present embodiment. FIG. 7B illustrates the band profile of a semiconductor part, which is obtained along a section of the electromagnetic-wave generation device of the present embodiment. FIG. 7C is a top view of the electromagnetic-wave generation device of the present embodiment. The present embodiment includes a combination of the second and third embodiments.

FIG. 7A illustrates an InP substrate 71 on which the present embodiment is provided, a Ti/Pd/Au electrode (first electrode) 701 provided on a passivation layer 705, and a potential barrier 702 including an 8-nanometer-thick InAlAs layer achieving a tunneling probability of 0.1% near the Fermi energy. FIG. 7A further illustrates a 100-nanometer-thick n-InGaAs layer 704 having an electron density of 1×10¹⁹ cm⁻³, and the Fermi energy of the n-InGaAs layer 704 lies near the bottom of the conduction band.

In this embodiment, the electrode 701, the n-InGaAs layer 704, and the InAlAs-potential barrier 702 constitute an emitter section. Therefore, the height of the InAlAs-potential barrier 702 matches up with the band offset between InGaAs and InAlAs, and the height value becomes of about 0.5 eV. A travel section 703 includes a 60-namometer-thick i-InGaAs layer, and a 100-nanometer-thick n-InP layer 712 has an electron density of 2×10¹⁹ cm⁻³ and a band gap of about 1.3 eV. Further, a Ti/Pd/Au electrode (a second electrode) 711 is provided.

In the present embodiment, the Ti/Pd/Au electrode 711 and the n-InP layer functioning as a sub-collector constitute a collector section. Each of the semiconductor layers includes a composition lattice-matched to the InP substrate 71. FIG. 7B illustrates the band profile of a semiconductor part of the present embodiment, which is calculated with the Poisson solver. The height of the InAlAs-potential barrier 702 can be increased by distorting the Al-composition-increasing side thereof so long as the height is not more than the critical film thickness. Otherwise, the height of the InAlAs-potential barrier 702 can be decreased by distorting the Al-composition-decreasing side thereof.

For performing operations of the present embodiment, a voltage of 1 V is applied from a voltage source 720 between the electrodes 701 and 711. Other specifics of the present embodiment are the same as those of the sixth embodiment. A laser device 730 is the same as that of the sixth embodiment. The n-InGaAs layer 704 provided directly above the InAlAs-potential barrier 702 is irradiated with femtosecond-pulse light 731. FIG. 7C illustrates a ring-shaped part of the first electrode 701. Since the electrode 701 includes a ring-shaped electrode part 706 so as not to interfere with the transmission of the femtosecond-pulse light 731, and part of the n-InGaAs layer 704 is exposed, the light efficiency of the present embodiment is increased. The time period τ during which an emitted current flows depends on the material of the InGaAs-travel section 703. The value of the electron-travel speed v_{d} of InGaAs is about 9×10⁷ cm/sec (see “K. Furuya et al, J. Phys.: Conf. Ser. Vol. 38, 208 (2006)” proposing a VFET configuration achieved based on the ballistic flight of an electron). Accordingly, it can be estimated that the equation τ=67 fsec holds based on the equation τ=d/Vd. Since a radiation pattern is radiated toward the InP substrate 71-side having high permittivity, a semi-insulating substrate 71 decreasing the loss of the THz wave may be used.

### Eighth Embodiment

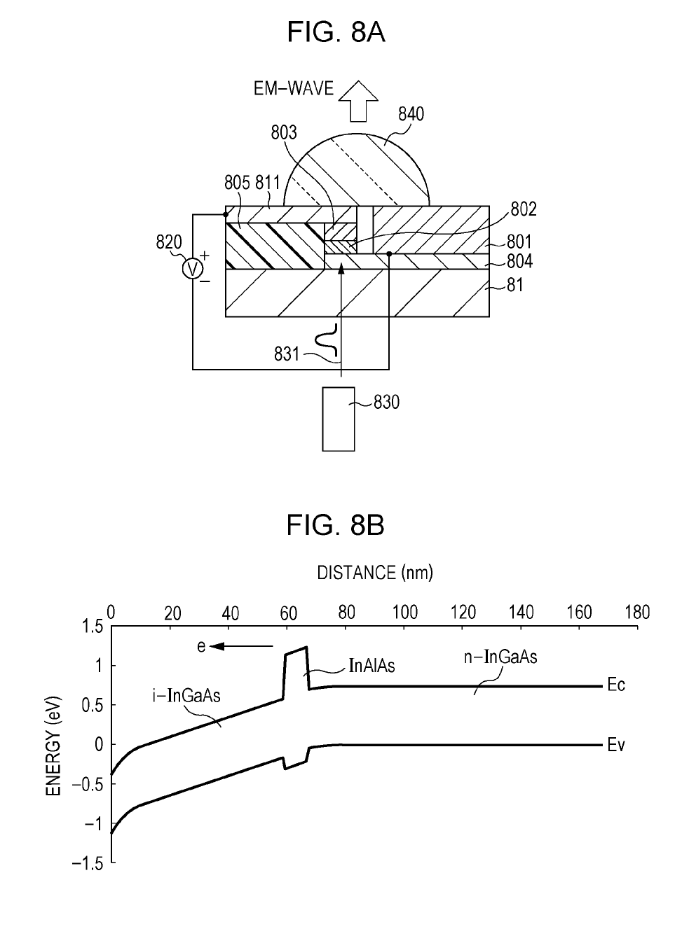

An electromagnetic-wave generation device according to an eighth embodiment of the present invention will be described with reference to FIGS. 8A and 8B. FIG. 8A is a sectional view of the electromagnetic-wave generation device of the present embodiment. FIG. 8B illustrates the band profile of a semiconductor part, which is obtained along a section of the electromagnetic-wave generation device of the present embodiment. FIG. 8A illustrates an InP substrate 81. The present embodiment is an exemplary modification of the seventh embodiment. That is, the n-InP layer 712 functioning as the sub-collector is eliminated and the position of the InP substrate 81 is flipped in the vertical direction on the drawing. In the present embodiment, therefore, only a Ti/Pd/Au electrode (second electrode) 811 provided on a passivation layer 805 constitutes a collector section. Due to the characteristics of the interface between Ti and InGaAs, the Ti/Pd/Au electrode 811 operates as a Schottky collector. Other specifics of the present embodiment are the same as those of the seventh embodiment.

That is, a Ti/Pd/Au electrode (first electrode) 801, an 8-nanometer-thick InAlAs-potential barrier 802, a 100-nanometer-thick n-InGaAs layer 804 having an electron density of 1×10¹⁹ cm⁻³, and a 60-nanometer-thick i-InGaAs travel section 803 are provided. In FIG. 8B illustrating the band profile of a semiconductor part of the present embodiment, the band profile being calculated with the Poisson solver, an electron flying within the i-InGaAs-travel section 803 travels toward the left side.

The operation method of the present embodiment is the same as that of the seventh embodiment, and a voltage source 820 applies a voltage to the gap between the electrodes 801 and 811. However, since femtosecond-pulse light 831 emitted from a laser device 830 passes through the InP substrate 81, the InP substrate 81 is provided as a semi-insulating substrate making the loss and/or the scattering of excitation light 831 of 1.5 μm band relatively small. In the present embodiment, a radiation pattern is controlled with the electrodes 801 and 811, which function as an antenna, and a dielectric lens 840 provided on the antenna, that is, the electrodes 801 and 811. Since the dielectric lens 840 includes an Si lens in the present embodiment, a terahertz wave is emitted upward as well.

### Ninth Embodiment

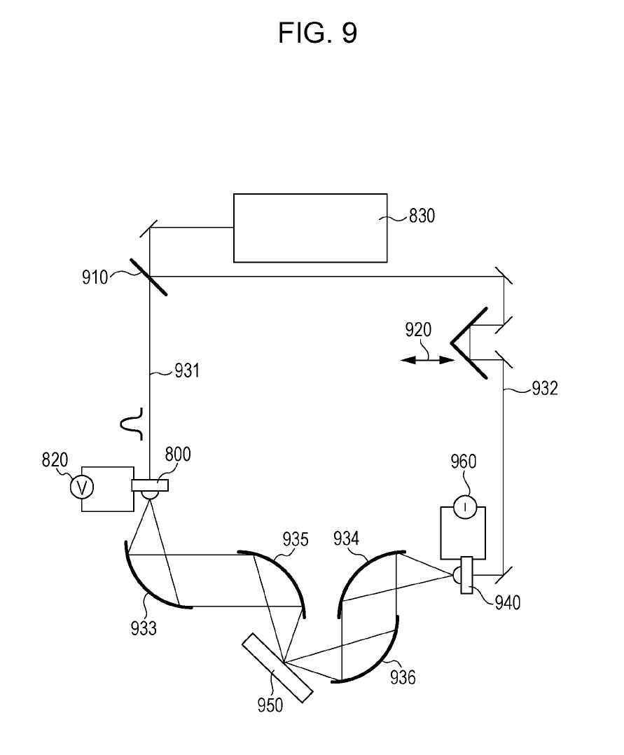

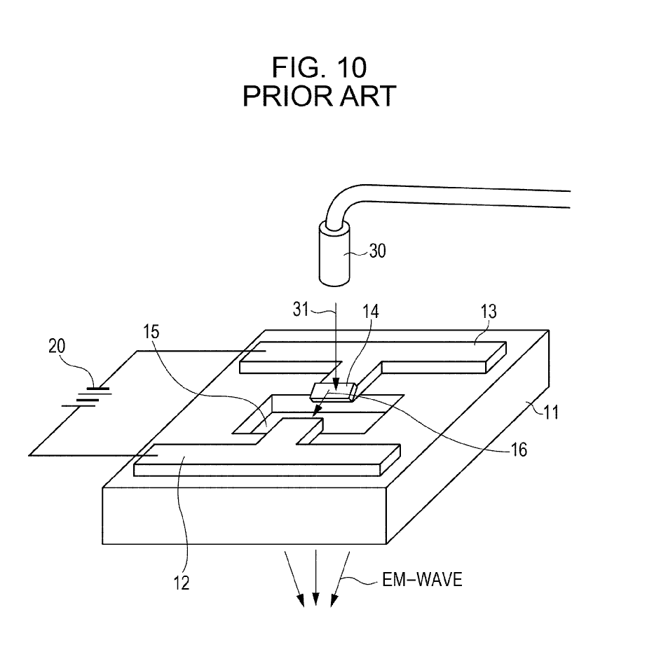

FIG. 9 illustrates a terahertz-time-domain spectroscopic system (THz-TDS) including an electromagnetic-wave generation device according to a ninth embodiment of the present invention. The above-described spectroscopic system itself is basically the same as a known spectroscopic system. The above-described spectroscopic system includes a short-pulse laser 830, a half mirror 910, a light-delay system 920, an electromagnetic-wave generation element (electromagnetic-wave generation device) 800, and an electromagnetic-wave detection element (electromagnetic-wave detection device) 940 as main elements. The electromagnetic-wave generation element 800 and the electromagnetic-wave detection element 940 are irradiated with individual pump light 931 and probe light 932.

A terahertz wave emitted from the electromagnetic-wave generation element 800 to which a voltage is applied from a voltage source 820 is guided to a sample 950 with terahertz guides 933 and 935. A terahertz wave including information about, for example, the absorption spectrum of the sample 950 is guided with terahertz guides 934 and 936, and is detected with the electromagnetic-wave detection element 940. At that time, the value of a detected current of an ammeter 960 is proportional to the amplitude of the terahertz wave. For performing the time resolution (that is, acquiring the time waveform of an electromagnetic wave), the timing when irradiation of the pump light 931 and the probe light 932 is performed may be controlled by, for example, moving the light delay system 920 changing an optical-path length obtained on the probe light 932-side. That is, a delay time between the time when an electromagnetic wave is generated with the electromagnetic-wave generation element 800 and the time when an electromagnetic wave is detected with the electromagnetic-wave detection element 960 is adjusted.

In the present embodiment, a photoconductive element including a low temperature-grown InGaAs layer provided for the 1.5 μm band is used as the electromagnetic-wave detection element 940. When a secondary harmonic generator (SHG crystal) is inserted on the probe light 932-side and the photoconductive element including the low temperature-grown InGaAs layer is used as the electromagnetic-wave detection element 940, the signal-noise ratio is increased even though the number of components is increased as well. Thus, it becomes possible to provide a terahertz-time-domain spectroscopic system including an electromagnetic-wave generation device according to an embodiment of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-041134 filed on Feb. 26, 2010, which is hereby incorporated by reference herein in its entirety.

What is claimed is:

1. An electromagnetic-wave generation device comprising:
an emitter section including a first electrode;
a collector section including a second electrode;
a carrier-travel section placed between the emitter section and the collector section;
a voltage-application unit configured to apply a voltage so that a potential of the second electrode becomes higher than a potential of the first electrode; and
a light-irradiation unit configured to radiate light,
wherein the carrier-travel section includes a first semiconductor extending along a direction in which an electron carrier travels, and
wherein the emitter section includes a second semiconductor that is formed in contact with the first semiconductor, and that achieves a potential barrier, and is configured so that the carrier goes beyond the potential barrier and is emitted to the carrier-travel section only when being irradiated with the light.

2. An electromagnetic-wave generation device comprising:
an emitter section including a first electrode;
a collector section including a second electrode;
a carrier-travel section placed between the emitter section and the collector section;
a voltage-application unit configured to apply a voltage so that a potential of the second electrode becomes lower than a potential of the first electrode; and
a light-irradiation unit configured to radiate light,
wherein the carrier-travel section includes a first semiconductor extending along a direction in which a hole carrier travels, and
wherein the emitter section includes a second semiconductor that is formed in contact with the first semiconductor, and that achieves a potential barrier, and is configured so that the carrier goes beyond the potential barrier and is emitted to the carrier-travel section only when being irradiated with the light.

3. The electromagnetic-wave generation device according to claim 1, wherein the first semiconductor has a length which is equivalent to or less than a mean free path extending along the direction in which the carrier travels.

4. The electromagnetic-wave generation device according to claim 1, wherein the first semiconductor is intrinsic or has an electron density or a hole density which is low enough to allow electric-field application.

5. The electromagnetic-wave generation device according to claim 1, wherein the emitter section includes a conductive semiconductor that is placed between the first electrode and the second semiconductor, and in contact with the second semiconductor, and that has a conductivity type equivalent to a conductivity type of the carrier.

6. The electromagnetic-wave generation device according to claim 1, wherein the collector section includes a semiconductor that has an energy gap larger than photon energy of the light and that has a conductivity type equivalent to a conductivity type of the carrier.

7. The electromagnetic-wave generation device according to claim 1, wherein the collector section, the carrier-travel section, and the emitter section are stacked on one another with the carrier-travel section being between the emitter section and the collector section.

8. The electromagnetic-wave generation device according to claim 1, wherein the first and second electrodes are composed of the same type of semiconductor material.

9. A time-domain spectroscopic system comprising:
the electromagnetic-wave generation device according to claim 1;
an electromagnetic-wave detection device configured to detect an electromagnetic wave generated from the electromagnetic-wave generation device; and
a delay system configured to adjust a delay time between time when the electromagnetic wave is generated from the electromagnetic-wave generation device and time when the electromagnetic wave is detected with the electromagnetic-wave detection device,
wherein a time waveform of the electromagnetic wave is acquired by changing the delay time with the delay system.

10. A time-domain spectroscopic system comprising:
the electromagnetic-wave generation device according to claim 2;
an electromagnetic-wave detection device configured to detect an electromagnetic wave generated from the electromagnetic-wave generation device; and
a delay system configured to adjust a delay time between time when the electromagnetic wave is generated from the electromagnetic-wave generation device and time when the electromagnetic wave is detected with the electromagnetic-wave detection device,
wherein a time waveform of the electromagnetic wave is acquired by changing the delay time with the delay system.
